(19) United States
(12) Patent Application Publication
(10) Pub. No.: US 2017/0346429 A1
(43) Pub. Date: Nov. 30, 2017

(54) CONTROLLER-INTEGRATED ROTATING ELECTRICAL MACHINE

(71) Applicant: DENSO CORPORATION, Kariya-city (JP)

(72) Inventors: Hiroshi INAMURA, Kariya-city (JP); Yuki SUZUKI, Kariya-city (JP); Koji KONDO, Kariya-city (JP); Nobuhiro ASANO, Kariya-city (JP); Yuki MAWATARI, Kariya-city (JP); Masataka YOSHIMURA, Kariya-city (JP)

(73) Assignee: DENSO CORPORATION, Kariya-city (JP)

(21) Appl. No.: 15/608,285

(22) Filed: May 30, 2017

(30) Foreign Application Priority Data
May 31, 2016 (JP) 2016-109476
Feb. 3, 2017 (JP) 2017-019082

(51) Int. Cl. H02P 9/00; H02P 9/02; H02P 8/06; H02P 11/06; H02P 25/026

(52) U.S. Cl. CPC H02P 9/009; H02P 9/02; H02P 8/06; H02P 25/026; H02P 11/06

(57) ABSTRACT

A controller-integrated rotating electrical machine incudes a rotating electrical machine and a control device. The rotating electrical machine is equipped with a stator and a rotor. The control device is equipped with a control circuit for an inverter circuit and an angle position sensing device which works to measure an angular position of the rotor. The control device has first substrate on which the control circuit is mounted and a second substrate on which the angle position sensing device is mounted. The first substrate is located closer to the rotating electrical machine than the angle position sensing device is in an axial direction of the controller-integrated rotating electrical machine. This minimizes adverse effects of magnetic flux, as generated by the rotating electrical machine, on operation of the angle position sensing device, thereby enhancing a measurement accuracy of the angle positon sensing device.

### CROSS REFERENCE TO RELATED DOCUMENT

The present application claims the benefit of priority of Japanese Patent Applications No. 2016-109476 filed on May 31, 2016 and No. 2017-19082 filed on Feb. 3, 2017, the disclosures of which are incorporated herein by reference.

### BACKGROUND

### 1. Technical Field

The invention relates generally to a controller-integrated rotating electrical machine equipped with a rotating electrical machine and a control device working to control operation of the rotating electrical machine.

### 2. Background Art

Controller-integrated rotating electrical machines are known which are equipped with a rotating electrical machine and a control device (also called an inverter assembly). The control device is equipped with power modules, heat sinks, connecting terminals, bus bars, and an insulator. The power modules are joined to the heat sinks through thermally conductive and electrically insulating adhesive. The connecting terminals and the bus bars are insert-molded in the insulator which constitutes a casing with an inner wall, an outer wall, and a flat wall. The insulator is joined to the heat sinks through adhesive. The power modules are disposed in recesses defined by the insulator and the heat sinks. Terminals of the power modules are joined to the connecting terminals and the bus bars. Electrically insulating filling material is disposed in the recesses as defined by the insulator and the heat sinks.

The controller-integrated rotating electrical machines are usually, like in a patent publication discussed below, equipped with a rotational angle sensor (also called an angle position sensor) to detect an angle of a rotor of the rotating electrical machine for use in controlling an operation of the rotating electrical machine.

Japanese Patent First Publication No. 2015-202049 teaches a controller-integrated rotating electrical machine working as an electrical drive mechanism which includes an electric motor (i.e., a rotating electrical machine), an object to be detected by a rotational angle sensor, and a sensing device of the rotational angle sensor aligned with an axis of the shaft of the motor. The object is attached to a shaft of the motor and made of a magnetic resolver rotor equipped with a protrusion. The sensing device of the rotational angle sensor is made up of a resolver stator core, a coil, and a connector. The resolver stator core is mounted on an outer periphery of the resolver rotor. The coil is made of an exciting winding and an output winding wound on the resolver stator core. The connector electrically joins the coil and a control board together. The resolver stator core of the sensing device is disposed in a recess formed in a heat sink. The heat sink and the control board are arranged to have major surfaces thereof extending perpendicular to the axis of the shaft of the motor.

The electrical drive mechanism (i.e., the controller-integrated rotating electrical machine) is designed to have the control board and the sensing device of the rotational angle sensor which are separate from each other in order for the control board to have an increased area on which parts are mounted. The distance between a bearing and the object which is detected by the rotational angle sensor and attached to the end of the shaft of the motor is short, thereby minimizing vibration of the object, which leads to an improved measurement accuracy of the rotational angle sensor and reduced vibrational noise of the motor.

The electrical drive mechanism, however, faces a drawback in that the sensing device of the rotational angle sensor is arranged closer to the object which is attached to the shaft of the motor and directly detected by the sensing device, so that they are adversely affected by magnetic flux generated by the rotating electrical machine, thereby resulting in a reduced measurement accuracy of the rotational angle sensor.

The electrical drive mechanism has the sensing device secured to the control board through the connector and also has power modules mounted on the control board, thereby resulting in an increase size of the control board. Such an increased size leads to a risk of deformation (e.g., warpage) of the control board, thus resulting in misalignment of the sensing device secured to the control board. This also results in a reduction in measurement accuracy of the rotational angle sensor.

### SUMMARY

It is therefore an object to provide a controller-integrated rotating electrical machine which is equipped with an angle positon sensor and designed to minimize a reduction in measurement accuracy of the angle position sensor which arises from magnetic flux generated by the rotating electrical machine.

According to one aspect of the invention, there is provided a controller-integrated rotating electrical machine which may be used in vehicles such as automobiles. The controller-integrated rotating electrical machine comprises: (a) a rotating electrical machine which is equipped with a stator with an armature winding and a rotor with a field winding; (b) a control device which is equipped with a control circuit and an angle position sensing device, the control circuit working to control an inverter circuit to supply electric power to said armature winding, the angle position sensing device working to measure an angular position of the rotor; (c) a first substrate on which the control circuit is mounted, the first substrate being disposed in the control device; and (d) a second substrate on which the angle position sensing device is mounted, the second substrate being disposed in the control device.

The first substrate is located closer to the rotating electrical machine than the angle position sensing device is in an axial direction of the rotor. The first substrate is arranged at a distance from the angle position sensing device.

In other words, the controller-integrated rotating electrical machine has the angle position sensing device located closer to a rear end of the controller-integrated rotating electrical machine than the first substrate is and arranged away from the first substrate. The angle position sensing device is, therefore, disposed farther away from the rotating electrical machine, so that the quantity of the magnetic flux which is produced by the rotating electrical machine and reaches the angle position sensing device is decreased, thus minimizing adverse effects of the magnetic flux on the operation of the angle position sensing device. The controller-integrated rotating electrical machine is, therefore, capable of minimizing a risk that the angle position sensing device produces an error in determining the rotational positon of the rotor due to the magnetic flux generated by the rotating electrical machine.

The controller-integrated rotating electrical machine is, as described above, equipped with the first substrate on which the control circuit is mounted and the second substrate on which the angle position sensing device is installed. The angle position sensing device is, therefore, not mounted on the first substrate on which the control circuit is installed. The first substrate is a substrate greater in size than the second substrate and has mounted thereon an electrical device which generates a large amount of heat. The first substrate, therefore, easily becomes thermally deformed. The first substrate has a large area, which facilitates deformation thereof when it is installed in the controller-integrated rotating electrical machine. The angle position sensing device is, as described above secured to the second substrate, so that it is not influenced by any deformation of the first substrate, thereby ensuring the stability of measurement accuracy of the angle position sensing device.

In the preferred modes of the invention, the control device of the controller-integrated rotating electrical machine is equipped with a switching module constituting the inverter circuit and a bus bar joined to the switching module. A joint between the switching module and the bus bar is located closer to the front of the controller-integrated rotating electrical machine than the switching module is in the axial direction of the controller-integrated rotating electrical machine.

The distance between the joint (i.e., the bus bar) and the angle position sensing device is relatively long, thereby resulting in a decrease in density of the magnetic flux, as generated by flow of electrical current through the joint or the bus bar, near the angle position sensing device. This minimizes adverse effects of the magnetic flux on the operation of the angle position sensing device.

The control device of the controller-integrated rotating electrical machine is also equipped with a heat sink which serve to dissipate heat generated by the switching module. The angle position sensing device is located closer to an axis of the rotor than the heat sink is in the radial direction of the rotor.

In other words, the angle position sensing device is arranged inside the heat sink in the radial direction of the rotor, so that cooling medium flowing through the heat sink reaches the angle position sensing device, thereby cooling the angle position sensing device and the second substrate.

The angle position sensing device is located closer the front of the controller-integrated rotating electrical machine than the rear end of the heat sink is in the radial direction of the controller-integrated rotating electrical machine.

In other words, the angle position sensing device lies closer to the rotating electrical machine than the rear end of the heat sink is in an axial direction of the rotating electrical machine, thereby resulting in a decreased dimension of the control device (i.e., the controller-integrated rotating electrical machine) in the axial direction of the controller-integrated rotating electrical machine.

The controller-integrated rotating electrical machine has the second substrate smaller in size than the first substrate.

Specifically, the second substrate on which the rotating position sensing device is mounted is smaller in size than the first substrate. This results in less deformation (i.e., warpage) of the second substrate than the first substrate.

The angle position sensing device installed in the controller-integrated rotating electrical machine is implemented by a magnetic angle sensor. The use of the magnetic angle sensor enables the angle position sensing device to be reduced in size thereof.

The control device of the controller-integrated rotating electrical machine has the first substrate and the second substrate at least one of which is covered with resin. This results in a decrease in heat-transfer resistance (i.e., thermal resistance) of the one of the first substrate and the second substrate and, thus, enhances dissipation of heat from the one of the first substrate and the second substrate.

The control device of the controller-integrated rotating electrical machine is equipped with a magnetic member which is located in the rear of the angle position sensing device in the axial direction of the controller-integrated rotating electrical machine.

The magnetic flux, therefore, flows through the magnetic member. This flow serves to minimize an undesirable variation or disturbance in magnetic flux passing through the angle position sensing device (i.e., magnetic flux detected by the angle position sensing device) which is located in front of the magnetic member, thereby ensuring the stability of measurement accuracy of the angle position sensing device.

Additionally, when some kind of member which generates electromagnetic noise (i.e., an electromagnetic noise source) is disposed outside the controller-integrated rotating electrical machine, the magnetic member which lies between the angle position sensing device and the electromagnetic noise source functions as a magnetic shield to protect the angle position sensing device from the electromagnetic noise, thus ensuring the stability of the measurement accuracy of the angle position sensing device.

The control device of the controller-integrated rotating electrical machine is equipped with a casing which stores therein the first substrate and the second substrate which are arranged between the magnetic member and the rear end of the rotating electrical machine. This arrangement facilitates attachment of the magnetic member to the casing.

The magnetic member is secured to or retained by one of the first substrate and the casing of the control device.

In other words, the magnetic member is arranged closer to the angle position sensing device, thereby reducing the disturbance in magnetic flux flowing from the rotating electrical machine to the angle position sensing device.

The control device of the controller-integrated rotating electrical machine is also equipped with a magnetic shield disposed between the second substrate and the rotating electrical machine.

The magnetic shield serves to block input of electromagnetic noise, as flowing from the rotating electrical machine to the second substrate, thereby minimizing adverse effects of the electromagnetic noise generated by the rotating electrical machine on the operation of the angle position sensing device, which ensures the stability of the measurement accuracy of the angle position sensing device.

According to another aspect of the disclosure, there is provided a controller-integrated rotating electrical machine which comprises: (a) a rotating electrical machine which is equipped with a stator with an armature winding and a rotor; (b) a control device which is equipped with a control circuit and an angle position sensing device, the control circuit working to control an inverter circuit to supply electric power to said armature winding, the angle position sensing device working to measure an angular position of the rotor; and (c) a magnetic member which is disposed behind a rear end of the angle position sensing device in an axial direction of the controller-integrated rotating electrical machine.

With the above arrangements, the magnetic flux flows from the rotating electrical machine, penetrates through the angle position sensing device, and then reaches the magnetic member located behind the angle position sensing device. The magnetic flux penetrating through the angle position sensing device arranged between the rotating electrical machine and the magnetic member will have a steady flow oriented in a single direction without undergoing a disturbance. This eliminates the disturbance in magnetic flux detected by the angle position sensing device, thereby ensuring the stability of the measurement accuracy of the angle position sensing device.

The controller-integrated rotating electrical machine may be designed to have the magnetic member attached to an outside surface of a casing of the control device.

It is easy to secure the magnetic member to the controller-integrated rotating electrical machine. The magnetic member functions to minimize the disturbance in magnetic flux flowing through the angle position sensing device. Usually, a variety of members such as the control circuit, etc., are disposed within the casing of the control device. In a case where the magnetic member is installed inside the casing, it is, therefore, necessary to place the magnetic member within the casing without mechanical interference with the other members. The attachment of the magnetic member to the outside surface of the casing of the control device, however, does not need consideration of such interference. In other words, the degree of freedom of the configuration or location of the magnetic member is high, thereby facilitating the ease with which the magnetic flux penetrating through the angle position sensing device is controlled to decrease the disturbance in the magnetic flux. It is also easy to secure the magnetic member to the outside surface of the casing of the control device.

The controller-integrated rotating electrical machine may have a magnetic member which is secured to one of the rotating electrical machine and the control device.

The securement of the magnetic member to one of the rotating electrical machine and the control device results in a great reduction in disturbance in the magnetic flux reaching the angle position sensing device and also minimizes misalignment of the angle position sensing device. This ensures the stability of the positional relationship between the rotating electrical machine and the magnetic member, thus ensuring the stability of the measurement accuracy of the angle position sensing device.

The controller-integrated rotating electrical machine may be designed to have the magnetic member equipped with a cable retainer which holds a cable such as an electrical power cable or a communication cable.

The use of the cable retainer attached to the magnetic member facilitates securement of the cable to the controller-integrated rotating electrical machine without use of additional fasteners. The securement of the cable to the controller-integrated rotating electrical machine minimizes a risk of breaking thereof or removal of a connector to which the cable is coupled.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is an axially sectional view of a controller-integrated rotating electrical machine according to the first embodiment;

FIG. 2 is a plan view which schematically illustrates a first wiring board and a second wiring board installed in a control device from which a cover is removed in the first embodiment;

FIG. 3 is a partial longitudinal sectional view which illustrates locations of joints of bus bars within the controller-integrated rotating electrical machine of FIG. 1;

FIG. 4 is a partially longitudinal sectional view which illustrates a controller-integrated rotating electrical machine according to the second embodiment;

FIG. 5 is a perspective view which illustrates a controller-integrated rotating electrical machine according to the third embodiment;

FIG. 6 is a plan view which illustrates a rear end of the controller-integrated rotating electrical machine of FIG. 5;

FIG. 7 is a view which demonstrates a flow of magnetic flux generated by an angle position sensing magnet attached to a rotation axis of the controller-integrated rotating electrical machine of FIG. 5;

FIG. 8 is a view which demonstrates a disturbance in a flow of magnetic flux generated by an angle position sensing magnet attached to a rotation axis of the controller-integrated rotating electrical machine of FIG. 5;

FIG. 9 is a view which demonstrates magnetic flux generated by an angle positon sensing device when a magnetic member is installed in the controller-integrated rotating electrical machine of FIG. 5;

FIG. 10 is a plan view which illustrates a modification of a controller-integrated rotating electrical machine according to the third embodiment; and

FIG. 11 is a plan view which illustrates another modification of a controller-integrated rotating electrical machine of the third embodiment.

### DESCRIPTION OF THE PREFERRED EMBODIMENTS

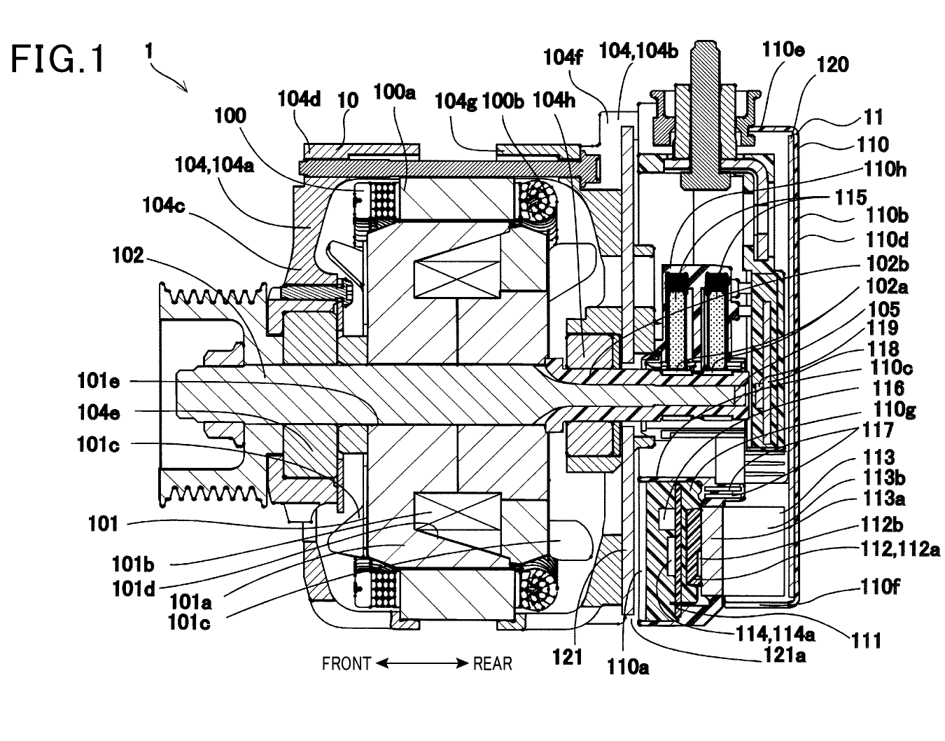

Referring to the drawings, particularly to FIGS. 1 to 3, the controller-integrated rotating electrical machine 1 according to an embodiment is shown. The rotating electrical machine 1, as referred to herein, is mounted on a vehicle such as an automobile.

### First Embodiment

The controller-integrated rotating electrical machine 1 shown in FIG. 1 is a device which is supplied with electric power from a storage battery mounted in the vehicle to produce a drive force to move the vehicle and to which a drive force or torque is supplied from an engine, such as an internal combustion engine mounted in the vehicle, to charge the storage battery. The controller-integrated rotating electrical machine 1 is equipped with the rotating electrical machine 10 and the control device 11.

In the following discussion, an axial direction represents a direction in which an axis of rotation of the rotor 101 of the rotating electrical machine 10 extends or a direction parallel to the axis of rotation of the rotor 10. As indicated in FIG. 1, a front or a front side represents a direction from the control device 11 to the rotating electrical machine 10 in the axial direction. A rear or a rear side represents a direction from the rotating electrical machine 10 to the control device 11 in the axial direction. A radial direction is a radial direction of the rotor 101, that is, a direction perpendicular to the axial direction.

### Rotating Electrical Machine

The rotating electrical machine 10 works as a drive force generator which is supplied with electric power to produce drive force to move the vehicle and also works as an electric power generator which is supplied with drive force from the engine to charge the storage battery. The rotating electrical machine 10 is equipped with the stator 100, the rotor 101, the housing 104, and the angle position sensing magnet 105.

The stator 100 constitutes a portion of a magnetic path and is supplied with electric power to generate magnetic flux. Specifically, the stator 100 works as a magnetic flux generator which is supplied with alternating current to generate magnetic flux and also works as an AC generator to produce alternating current through interlinkage with magnetic flux, as generated by the rotor 101. The stator 100 is equipped with the stator core 100a and the armature winding 100b.

The stator core 100a constitutes a portion of the magnetic path and is made of an annular member formed by a magnetic material. The stator core 100a retains the armature winding 100b therein. Although not illustrated, the stator core 100a has a plurality of slots through which the armature winding 100b is wound.

The armature winding 100b is supplied with alternating current to produce magnetic flux and also produce alternating current through interlinkage with magnetic flux, as generated by the rotor 101. The armature winding 100b is made up of two y-connected three-phase windings. The armature winding 100b is retained in the slots of the stator core 100a.

The rotor 101 constitutes a portion of the magnetic path and is supplied with electric power to produce magnetic flux. Specifically, the rotor 101 is supplied with direct current to generate magnetic flux and also produce torque through interlinkage with magnetic flux, as generated by the armature winding 100b. The rotor 101 is also rotated by drive force supplied from the engine mounted in the vehicle to produce magnetic flux which magnetically links with the armature winding 100b, so that the armature winding 100b produces alternating current. The rotor 101 is equipped with the rotor core 101a, the field winding 101b, and the fans 101c, and the rotating shaft 102.

The rotor core 101a constitutes a portion of the magnetic path and is made of a magnetic material. The rotor core 101a is a so-called Lundell-pole core and retains the field winding 101b therein. The rotor core 101a is equipped with the annular hollow portion 101d in which the field winding 101b is disposed and also has the through-hole 101e through which the rotating shaft 102 passes and which retains the rotating shaft 102 therein.

The field winding 101b is supplied with direct current to produce magnetic flux, thereby creating magnetic poles on an outer periphery of the rotor core 101a. The field winding 101b is disposed and retained in an annular hollow portion of the rotor core 101a.

The fans 101c are mounted on the rotor core 101a and rotated together with the rotor core 101a to suck fresh air from outside the controller-integrated rotating electrical machine 1 into the rotating electrical machine 10 and the control device 11. The fans 101c are arranged on a front end surface and a rear end surface of the rotor core 101a, respectively.

The rotor 101 is arranged to have the rotor core 101a whose outer peripheral surface faces an inner peripheral surface of the stator core 100a through a given gap.

The rotating shaft 102 is secured to the rotor 101 and retained by the housing 104 to be rotatable. The rotating shaft 102 is of a cylindrical shape and rotated together with the rotor 101. The rotating shaft 102 passes the through-hole 101e of the rotor 101 and has a central portion of a length thereof retained by the rotor core 101a. The rotating shaft 102 is equipped with the slip rings 102a.

The slip rings 102a are made of metallic cylinders which work to supply direct current to the field winding 101b. The slip rings 102a are mounted on an outer peripheral surface of a rear end portion of the rotating shaft 102 through the electric insulator 102b. The slip rings 102a are joined to the electric insulator 102b and connected to the field winding 101b through conductive wires.

The housing 104 covers axially opposed ends of the stator 100 and axially opposed ends of the rotor core 101a of the rotor 101 and retains the rotating shaft 102 to be rotatable. The control device 11 is secured to the housing 104. The housing 104 is equipped with the front housing 104a and the rear housing 104b.

The front housing 104a covers the front end portions of the stator 100 and the rotor core 101a of the rotor 101 and holds a front side of the rotating shaft 102 to be rotatable. The front housing 104a includes the bottom 104c and the peripheral wall 104d. The bottom 104c has through-holes formed therein. The peripheral wall 104d has though-holes formed therein. The front housing 104a has the peripheral wall 104d secured to the front end of the stator core 100a so as to cover the front end portions of the stator 100 and the rotor core 101a of the rotor 101. The front housing 104a retains the front side of the rotating shaft 102 to be rotatable through the bearing 104e with the front end of the rotating shaft 102 protruding frontward outside the front housing 104a.

The rear housing 104b covers the rear end portions of the stator 100 and the rotor core 101a of the rotor 101 and retains the rear side of the rotating shaft 102 to be rotatable. The control device 11 is secured to the rear housing 104b. The rear housing 104b includes the bottom 104f and the peripheral wall 104g. The bottom 104f has at least one through-hole formed therein. Similarly, the peripheral wall 104g has through-holes formed therein. The rear housing 104b has the peripheral wall 104g secured to the rear end of the stator core 100a so as to cover the rear end portions of the stator 100 and the rotor core 101a of the rotor 101. The rear housing 104b retains the rear side of the rotating shaft 102 to be rotatable through the bearing 104h with the rear end of the rotating shaft 102 protruding rearward outside the rear housing 104b.

The angle position sensing magnet 105 serves to produce magnetic field for measuring a rotational position (i.e., an angular position) of the rotor 101. The angle position sensing magnet 105 is retained in a magnetic holder and secured to the rear end of the rotating shaft 102.

### Control Device

The control device 11 works as a controller to control electric power outputted from the storage battery to the rotating electrical machine 10 to produce the drive force. The control device 11 also works to transform electric power, as produced by the rotating electrical machine 10, to be supplied to the storage battery for charging the storage battery.

The control device 11, as illustrated in FIGS. 1, 2, and 3, includes the casing 110, the first wiring board 111, the inverter circuit 112, the field circuit 114, the brushes 115, the control circuit 116, the inverter bus bars 117, the second wiring board 118, the angle position sensing device 119, the magnetic member 120, and the magnetic shield 121.

The casing 110 is formed by a resinous box and disposed on the rear end of the rear housing 104b to store the first wiring board 111, the inverter circuit 112, the field circuit 114, the brushes 115, the control circuit 116, the second wiring board 118, and the angle position sensing device 119. The casing 110 also serves as a retainer to firmly retain the inverter bus bars 117, and other conductive bus bars. The casing 110 includes the body 110a and the cover 110b.

The body 110a has the inverter circuit 112, the field circuit 114, and the control circuit 116 secured thereto and retains the brushes 115 to be movable in the radial direction thereof. The body 110a also has the inverter bus bars 117 and other conductive bus bars secured thereto. The body 110a has the through-hole 110c formed in the center thereof. The body 110a is secured to the rear end of the rear housing 104b. The radial direction, as referred to herein, is a direction perpendicular to the rotating axis of the rotating electrical machine 10, in other words, a direction perpendicular to the length of the rotating shaft 102.

The cover 110b covers the rear side of the body 110a. The cover 110b includes the bottom 110d and the peripheral wall 110e. The peripheral wall 110e has a plurality of openings 110f facing the fins 113b of the heat sinks 113, respectively, which will be described later in detail.

The first wiring board 111 is a substrate on which the inverter circuit 112, the field circuit 114, and the control circuit 116 are mounted. The first wiring board 111 is also an inner wiring substrate which wires among the circuits 112, 114, and 116. The first wiring board 111 has wiring patterns formed on an outer surface thereof and also formed therein. The first wiring board 111 will also be referred to below as a first substrate.

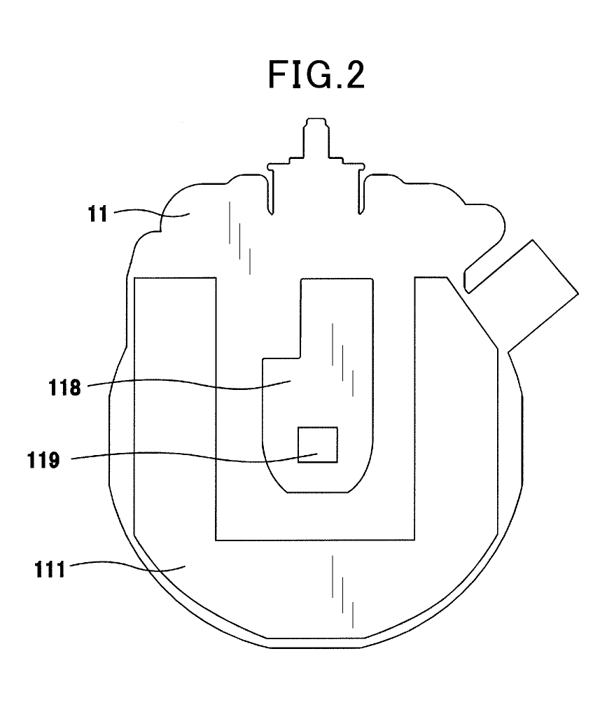

The first wiring board 111 is, as clearly illustrated in FIG. 2, of a U-shape. The first wiring board 111 is fixed within the casing 110 and surrounds the brush holder 110h at a distance therefrom. The first wiring board 111 is located closer to the front of the controller-integrated rotating electrical machine 1 than the inverter circuit 112 is and arranged at a distance away from the rear housing 104b and the inverter circuit 112. The first wiring board 111 has the outer surface coated with resin 110g. The inverter circuit 112 and the control circuit 116 are also hermetically sealed by the resin 110a within the casing 110.

The inverter circuit 112 is a circuit working to supply alternating current (i.e., electric power) to the armature winding 100b and also convert alternating current, as outputted from the armature winding 100b to direct current. The inverter circuit 112 is equipped with three switching modules 112a. The inverter circuit 112 is disposed in the casing 110 at a given interval away from the rear housing 104b.

The armature winding 100b is, as described above, made up of two three-phase windings. The inverter circuit 112 is, therefore, equipped with two three-phase inverters. Each of the three-phase inverters is made up of six inverter switching devices 112b. The inverter circuit 112 is, therefore, equipped with the total twelve inverter switching devices 112b.

Each of the switching modules 112a is made up of four of the inverter switching devices 112b which constitute the inverter circuit 112.

The heat sinks 113 are provided one for each of the switching modules 112a. The heat sinks 113 are made of a metallic member and work to dissipate heat, as generated by the inverter switching devices 112b of the switching modules 112a. Each of the heat sinks 113 includes the body (also called a heat sink base) 113a and the fins 113b.

The body 113a is made of a rectangular plate. The fins 113b are each made of a thin plate and arranged on a first surface that is one of major surfaces of the body 113a at given intervals away from each other.

The heat sinks 113 are insert-molded in the body 110a of the casing 110 and located away from the rear housing 104b. The body 113a of each of the heat sinks 113 has a second surface that is opposite the first surface thereof on which the fins 113b are mounted. The second surface of the body 113a is exposed to the rotating electrical machine 10. The fins 113b extend away from the rotating electrical machine 10. The switching modules 112a are arranged closer to the rotating electrical machine 10 (i.e., the axial front of the controller-integrated rotating electrical machine 1) than the heat sinks 113 are and placed in contact with the heat sinks 113 (i.e., the body 113a). In other words, the heat sinks 113 are on the opposite side of the inverter switching devices 112b to the rotating electrical machine 10 in contact with the inverter switching devices 112b, respectively. Each of the inverter switching devices 112b is practically placed in contact with one of the heat sinks 113 through a thermally conductive adhesive, grease, or sheet, but may be arranged in direct contact with the body 113a of one of the heat sinks 113. The switching modules 112a are arranged adjacent at a given interval away from each other in the circumferential direction of the rotating electrical machine 10. Similarly, the heat sinks 113 are arranged adjacent at a given interval away from each other in the circumferential direction of the rotating electrical machine 10.

The inverter circuit 112 is mounted on the first wiring board 111 in connection with the inverter bus bars 117. The inverter bus bars 117 are made of metallic conductors electrically connecting with the inverter circuit 112. The inverter bus bars 117 are insert-molded in the body 110a of the casing 110. The inverter bus bars 117 have end portions 117a (i.e., joints) connected to the inverter circuit 112. The end portions 117a are insert-molded in the body 110a of the casing 110 and located inside the fins 113a in the radial direction and closer to the front of the controller-integrated rotating electrical machine 1 than the fins 113a are.

The inverter circuit 112 also connects with armature winding bus bars (not shown) which are made of metallic conductors and electrically connect the switching modules 112a with the armature winding 100b. Joints between the armature winding bus bars and the armature winding 100b are, like the joints 117a of the inverter bus bars 117, arranged closer to the rear of the rotating electrical machine 10 than the first wiring board 111 is and located between circumferentially adjacent two of the switching modules 112a and between circumferentially adjacent two of the heat sinks 113.

The field circuit 114 works to supply direct current to the field winding 101b. The field circuit 114 is equipped with field switching devices 114a. The field switching devices 114a are placed in contact with the first wiring board 111.

The brushes 115 work to deliver direct current from the field circuit 114 to the field winding 101b through the slip rings 102a. The brushes 115 are disposed in the casing 110. Specifically, the body 110a of the casing 10 has the brush holder 110h located in the center thereof. The brushes 115 are retained in the brush holder 110h and located away from the rear housing 104b, the inverter circuit 112, and the control circuit 116.

The control circuit 116 works to control operations of the inverter circuit 112 and the field circuit 114. The control circuit 116 is equipped with electronic devices which are mounted thereon.

The second wiring board 118 is a substrate on which the angle position sensing device 119 is mounted. The angle position sensing device 119 works to measure the angular position of the rotor 101 using the magnetic field produced by the angle position sensing magnet 105. The second wiring board 118 has mounted thereon the rotational positon sensing device 119 and a circuit for determining the rotational position (i.e., the angular position) of the rotor 101 through the angle position sensing device 119. The second wiring board 118 is also an inner wiring substrate or plate which wires the angle position sensing device 119 thereon. The second wiring board 118 has wiring patterns formed on an outer surface thereof and also formed therein. The second wiring board 118 will also be referred to below as a second substrate.

The second wiring board 118, as can be seen in FIG. 1, extend in a direction perpendicular to the axial direction of the rotating electrical machine 10 within the casing 110. The second wiring board 118 has a front surface and a rear surface opposed to the front surface in the axial direction of the rotating electrical machine 10. The second wiring board 118 has the angle position sensing device 119 mounted on the front surface. The angle position sensing device 119 is arranged in the rear of the angle position sensing magnet 105 in the axial direction. In other words, the angle position sensing device 119 is aligned with the rear end of the angle position sensing magnet 105 at a distance therefrom and located closer to the rear of the controller-integrated rotating electrical machine 1 than the angle position sensing magnet 105 is.

The second wiring board 118 is, as clearly illustrated in FIG. 2, made of a strip plate which has a length with a first end and a second end opposed to each other and extends in the radial direction. The second wiring board 118 has the angle position sensing device 119 mounted on the first end (i.e. an inside end, as viewed in FIG. 2, closer to the center of the control device 11 than the second end is). The second end of the second wiring board 118 (i.e., an outside end, as viewed in FIG. 2) has a width smaller than that of the first end. As viewed in FIG. 2, the second wiring board 118 is oriented to have the length extending along a space surrounded by an opening of the U-shaped first wiring board 111 and three sides of the first wiring board 111. The first end of the first wiring board 111 on which the angle position sensing device 119 is mounted is arranged within the above space behind the rear end of the angle position sensing magnet 105 in the axial direction.

The second wiring board 118 is smaller in area than the first wiring board 111. The second wiring board 118 is hermetically sealed by the resin 110g within the casing 110 so that the outer surface of the second wiring board 118 is covered with the resin 110g.

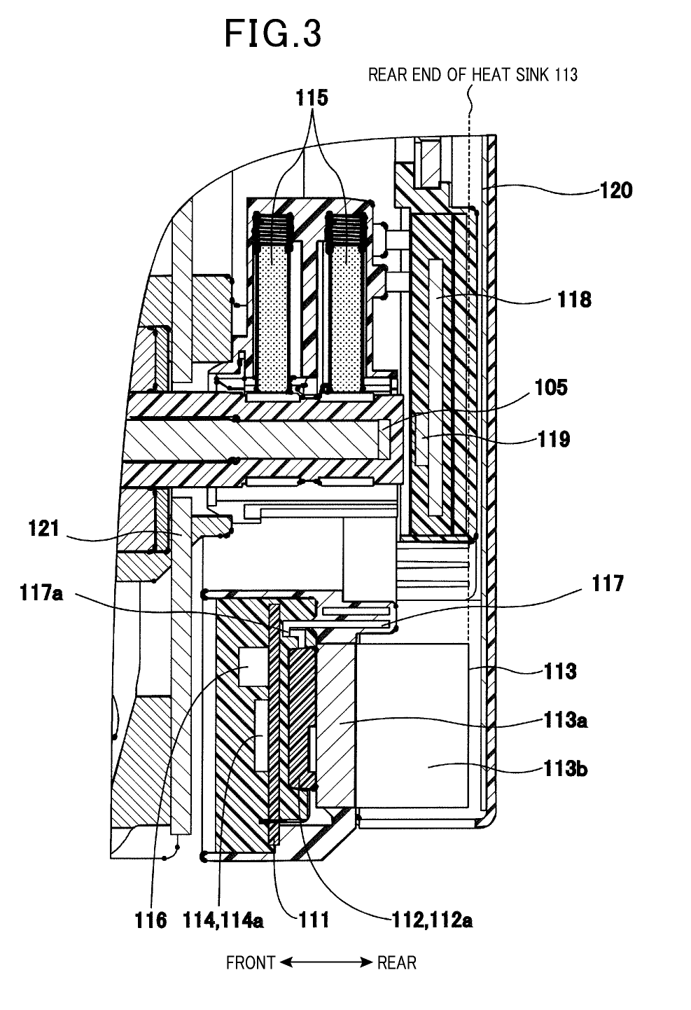

The second wiring board 118 and the angle position sensing device 119 installed on the second wiring board 118 are, as can be seen in FIG. 3, located closer to the front of the controller-integrated rotating electrical machine 1 than the rear ends of the heat sinks 113 are in the axial direction of the controller-integrated rotating electrical machine 1. The rear ends of the heat sinks 113 face the rear of the controller-integrated rotating electrical machine 1. The angle position sensing device 119 is also arranged closer to the rear of the controller-integrated rotating electrical machine 1 than the front ends of the heat sinks 113 are in the axial direction. In other words, the angle position sensing device 119 is disposed in a space defined around the axis of the controller-integrated rotating electrical machine 1 inside the heat sinks 113 when the heat sinks 113 are rotated in a circumferential direction of the rotating electrical machine 10 around the axis of the rotating electrical machine 10.

The angle position sensing device 119 is a sensor designed to detect a magnetic field (i.e., magnetic flux) generated by the angle position sensing magnet 105. Specifically, the angle position sensing device 119 is implemented by a magnetic sensor (i.e., a magnetic angle sensor).

The magnetic member 120 is formed by a magnetic plate. The magnetic plate is made of a soft magnetic material. Specifically, the magnetic plate is made of ferrous metal such iron. The magnetic member 120 is larger in area than the second wiring board 118. The magnetic member 120 is located closer to the rear of the controller-integrated rotating electrical machine 1 than the rear ends of the second wiring board 118 and the angle position sensing device 119 mounted on the second wiring board 118 are in the axial direction and arranged at a distance from the second wiring board 118 and the angle position sensing device 119. The magnetic member 120 has a major surface extending parallel to a direction in which the major surface of the second wiring board 118 extends. The magnetic member 120 is firmly secured to the cover 110b of the casing 110.

The magnetic shield 121 is, like the magnetic member 120, formed by a magnetic plate. The magnetic shield 121 is located closer to the front of the controller-integrated rotating electrical machine 1 than the rear end of the first wiring board 111 is in the axial direction and arranged at a distance from the first wiring board 111. The magnetic shield 121 has a major surface extending parallel to a direction in which the major surface of the first wiring board 111 extends. Specifically, the magnetic shield 121 is firmly secured to the rear end of the rear housing 104b of the rotating electrical machine 10 which faces the rear of the controller-integrated rotating electrical machine 1.

### Operation of Controller-Integrated Rotating Electricla Machine

The operation of the controller-integrated rotating electrical machine 1 will be described below in detail with reference to FIGS. 1, 3, and 4. The controller-integrated rotating electrical machine 1 (i.e., the rotating electrical machine 10) is selectively operable in a motor mode and a generator mode. The motor mode will first be discussed which produces the drive force to move the vehicle.

When an ignition switch of the vehicle is turned on, the direct current is delivered to the switching modules 112a of the inverter circuit 112 through the inverter bus bars 117. The direct current is also supplied to the field circuit 114 and the control circuit 116 through other conductive bus bars and the first wiring board 111.

Upon the supply of the direct current, the field circuit 114 and the control circuit 116 start operating. The control circuit 116 is responsive to commands inputted from an external device to control the operations of the inverter circuit 112 and the field circuit 114. The field circuit 114 is controlled by the control circuit 116 to deliver the direct current to the field winding 101b through the brushes 115 and the slip rings 102a. The inverter circuit 112 is controlled by the control circuit 116 to convert the direct current, as inputted through the inverter bus bars 117, into alternating current and supplies it to the armature winding 100b through the above described armature winding bus bars. This causes the rotating electrical machine 10 to operate in the motor mode to produce the drive force to move the vehicle.

When the rotating electrical machine 10 is outputting the drive force, the rotor 101 and the rotating shaft 102 are rotating. The angle position sensing magnet 105 attached to the rear end of the rotating shaft 102 is also rotating, so that the magnetic flux changes near the angle position sensing magnet 105. The angle position sensing device 119 detects such a change in magnetic flux to determine the state of rotation of the rotor 101 and the rotating shaft 102. The state of rotation is used by the control circuit 116 to control rotation of the controller-integrated rotating electrical machine 1.

Next, the generator mode of the controller-integrated rotating electrical machine 1 to charge the storage battery mounted in the vehicle will be described below.

When the generator mode is entered, the rotating electrical machine 10 is supplied with the drive power from the engine mounted in the vehicle, so that the armature winding 100b generates alternating current. The control circuit 116 stops switching the inverter switching devices 112b of the switching modules 112a. Diodes installed in the inverter switching devices 112b work to convert the alternating current, as delivered from the armature winding 100b through the armature winding bus bars into direct current and then outputs it to the storage battery mounted in the vehicle. The storage battery is, thus, charged by the electric power generated by the rotating electrical machine 10. The control circuit 116 may be designed to turn on or off the inverter switching devices 112b of the switching modules 112a as a function of an angle of rotation of the rotor 101, as derived by the angle position sensing device 119, to convert three-phase alternating current, as produced by the armature winding 100b, into direct current.

The stop of the switching operations of the inverter switching devices 112b is achieved by sensing the rotation of the rotor 101 and the rotating shaft 102 operated by the drive force outputted from the engine.

### Beneficial Advantages

The beneficial advantages, as offered by the controller-integrated rotating electrical machine 1 of this embodiment will be described below.

The controller-integrated rotating electrical machine 1 includes the rotating electrical machine 10 and the control device 11. The rotating electrical machine 10 is equipped with the stator 100 with the armature winding 100b and the rotor 101 with the field winding 101b. The control device 11 is equipped with the control circuit 116 which controls the operations of the inverter circuit 112 which delivers the electric power to the armature winding 100b. The control device 11 also includes the angle position sensing device 119 which measures the rotational position of the rotor 101. The control device 11 is equipped with the first wiring board 111 on which the control circuit 116 is mounted and the second wiring board 118 on which the angle position sensing device 119 is installed. The first wiring board 111 is located closer to the rotating electrical machine 10 (i.e., the front of the controller-integrated rotating electrical machine 1) than the angle position sensing device 119 is in the axial direction of the rotor 101 (i.e., the controller-integrated rotating electrical machine 1). The first winding board 111 is arranged at a distance from the angle position sensing device 119 in the axial direction of the rotor 101.

In other words, the controller-integrated rotating electrical machine 1 has the angle position sensing device 119 located closer to the rear end of the controller-integrated rotating electrical machine 1 than the first wiring board 111 is and arranged away from the first wiring board 111. The angle position sensing device 119 is, therefore, disposed farther away from the rotating electrical machine 10, so that the magnetic flux produced by the rotating electrical machine 10 hardly reaches the angle position sensing device 119, thus minimizing adverse effects of the magnetic flux generated by the rotating electrical machine 10 on the operation of the angle position sensing device 119. The controller-integrated rotating electrical machine 1 is, therefore, capable of minimizing a risk that the angle position sensing device 119 produces an error in determining the rotational positon of the rotor 101 due to the magnetic flux generated by the rotating electrical machine 10.

The controller-integrated rotating electrical machine 1 is, as described above, equipped with the first wiring board 111 on which the control circuit 116 is mounted and the second wiring board 118 on which the angle position sensing device 119 is installed. The angle position sensing device 119 is, therefore, not mounted on the first wiring board 111 on which the control circuit 116 is installed. The first wiring board 111 is a substrate greater in size than the second wiring board 118 and has mounted thereon electrical devices which generate a large amount of heat. The first wiring board 111 is, therefore, easy to thermally deform. The first wiring board 111 has a large area, which facilitates deformation thereof when it is installed in the controller-integrated rotating electrical machine 1. The angle position sensing device 119 is, as described above secured to the second wiring board 118, so that it is not influenced by any deformation of the first wiring board 111, thereby ensuring the stability of measurement accuracy of the angle position sensing device 119.

The control device 11 of the controller-integrated rotating electrical machine 1 is equipped with the switching modules 112a constituting the inverter circuit 112 and the inverter bus bars 117 joined to the switching modules 112a. The joints 117a between the switching modules 112a and the inverter bus bars 117 are located closer to the front of the controller-integrated rotating electrical machine 1 (specifically, the rear end of the rotating electrical machine 10) than the switching modules 112a is in the axial direction of the controller-integrated rotating electrical machine 1.

The distance between the joints 117a (i.e., the inverter bus bars 117) and the angle position sensing device 119 is relatively long, thereby resulting in a decrease in density of the magnetic flux, as generated by flow of electrical current through the joints 117a or the inverter bus bars 117, near the angle position sensing device 119. This minimizes the adverse effects of the magnetic flux on the operation of the angle position sensing device 119.

The control device 11 of the controller-integrated rotating electrical machine 1 is equipped with the switching modules 112a constituting the inverter circuit 112 and the heat sinks 113 which serve to dissipate heat generated by the switching modules 112a. The angle position sensing device 119 is located closer to the axis of the rotor 101 (i.e., the center of the controller-integrated rotating electrical machine 1) than the heat sinks 113 are in the radial direction of the rotor 101.

In other words, the angle position sensing device 119 is arranged inside the heat sinks 113 in the radial direction of the rotor 101, so that cooling medium flowing through the heat sinks 113 (i.e., air moving through a first cooling flow path defined by the casing 110 and the rear housing 104b) hits the angle position sensing device 119, thereby cooling the angle position sensing device 119 (and the second wiring board 118).

More specifically, rotation of the rotor 101 of the controller-integrated rotating electrical machine 1 will cause the fan 101c to create flows of air (i.e., cooling medium) to cool the control device 11. The controller-integrated rotating electrical machine 1 is equipped with cooling flow paths (i.e., the first cooling flow path) defined the casing 110 and the rear housing 104b.

The cooling flow paths extend from the openings 110f of the cover 110b to outside the rear housing 104b through the heat sinks 113 and the rear housing 104b. Each of the cooling flow paths delivers a flow of air to a corresponding one of the heat sinks 113, directs the flow of air, as having passed through the one of the heat sinks 113, into the rear housing 104b, and then discharges the flow of air outside the rear housing 104b. Such flows of air also cool the angle position sensing device 119 (i.e., the second wiring board 118).

The controller-integrated rotating electrical machine 1 is also equipped with a second cooling flow path which delivers a flow of air between the control circuit 116 and the rear housing 104b, directs the flow of air, as having passed between the control circuit 116 and the rear housing 104b, into the rear housing 104b, and then discharges the flow of air outside the rear housing 104b.

The control device 11 of the controller-integrated rotating electrical machine 1 is, as described above, equipped with the switching modules 112a constituting the inverter circuit 112 and the heat sinks 113 which serve to dissipate heat generated by the switching modules 112a. The angle position sensing device 119 is located closer the front of the controller-integrated rotating electrical machine 1 than the rear ends of the heat sinks 113 are in the radial direction of the controller-integrated rotating electrical machine 1.

In other words, the angle position sensing device 119 lies closer to the rotating electrical machine 10 than the rear ends of the heat sinks 113 are in the axial direction of the rotating electrical machine 10, thereby resulting in a decreased dimension of the control device 11 (i.e., the controller-integrated rotating electrical machine 1) in the axial direction of the controller-integrated rotating electrical machine 1.

The controller-integrated rotating electrical machine 1 has the second wiring board 118 smaller in size than the first wiring board 111.

Specifically, the second wiring board 118 on which the rotating position sensing device 119 is mounted is smaller in size (e.g., surface area or projected area as viewed from the axial direction of the controller-integrated rotating electrical machine 1) than the first wiring board 111. This results in less deformation (i.e., warpage) of the second wiring board 118 than the first wiring board 111.

The angle position sensing device 119 installed in the controller-integrated rotating electrical machine 1 is implemented by a magnetic angle sensor. The use of the magnetic angle sensor enables the angle position sensing device 119 to be reduced in size thereof.

The smaller size of the second wiring board 118 usually results in a decreased heat capacity thereof. The second wiring board 118 is, therefore, less sensitive to heat transmitted from the switching modules 112a mounted on the first wiring board, thereby avoiding undesirable deformation of the second wiring board 118, that is, minimizing misalignment of the angle position sensing device 119.

The control device 11 of the controller-integrated rotating electrical machine 1 has the first wiring board 111 and the second wiring board 118 at least one of which is covered with resin. This results in a decrease in heat-transfer resistance (i.e., thermal resistance) of the one of the first wiring board 111 and the second wiring board 118 and, thus, enhances dissipation of heat from the one of the first wiring board 111 and the second wiring board 118.

The control device 11 of the controller-integrated rotating electrical machine 1 is equipped with the magnetic member 120 which is located in the rear of the angle position sensing device 119 in the axial direction of the controller-integrated rotating electrical machine 1.

The magnetic flux, therefore, flows through the magnetic member 120. This flow serves to minimize disturbance in the magnetic flux passing through the angle position sensing device 119 (i.e., magnetic flux detected by the angle position sensing device 119) which is located in front of the magnetic member 120, thereby ensuring the stability of measurement accuracy of the angle position sensing device 119. In a case where a second magnetic member, such as wire harness, is arranged near the control device 11 or the controller-integrated rotating electrical machine 1 in the absence of the magnetic member 120, the magnetic flux passing through the angle position sensing device 119 (i.e., magnetic flux detected by the angle position sensing device 119) will flow through the second magnetic member. In other words, the presence of the second magnetic member will result in disturbance in the magnetic flux detected by the angle position sensing device 119, which decreases the measurement accuracy of the angle position sensing device 119.

The use of the magnetic member 120, however, serves to reduce the disturbance in the magnetic flux passing through the angle position sensing device 119, thereby ensuring the stability of the measurement accuracy of the angle position sensing device 119.

Additionally, when some kind of member which generates electromagnetic noise (i.e., an electromagnetic noise source) is disposed outside the controller-integrated rotating electrical machine 1, the magnetic member 120 which lies between the angle position sensing device 119 and the electromagnetic noise source functions as a magnetic shield to protect the angle position sensing device 119 from the electromagnetic noise.

The control device 11 of the controller-integrated rotating electrical machine 1 is equipped with the casing 110 which stores therein the first wiring board 111 and the second wiring board 118 which are arranged between the magnetic member 120 and the rear end of the rotating electrical machine 10. This arrangement facilitates attachment of the magnetic member 120 to the casing 110.

The control device 11 of the controller-integrated rotating electrical machine 1 is equipped with the magnetic shield 121 disposed between the second wiring board 118 and the rotating electrical machine 10. The magnetic shield 121 serves to block input of electromagnetic noise, as transmitted from the rotating electrical machine 10 backward in the axial direction of the rotating electrical machine 10, to the second wiring board 118, thereby mitigating adverse effects of the electromagnetic noise generated by the rotating electrical machine 10 on the operation of the angle position sensing device 119, which ensures the stability of the measurement accuracy of the angle position sensing device 119.

### Second Embodiment

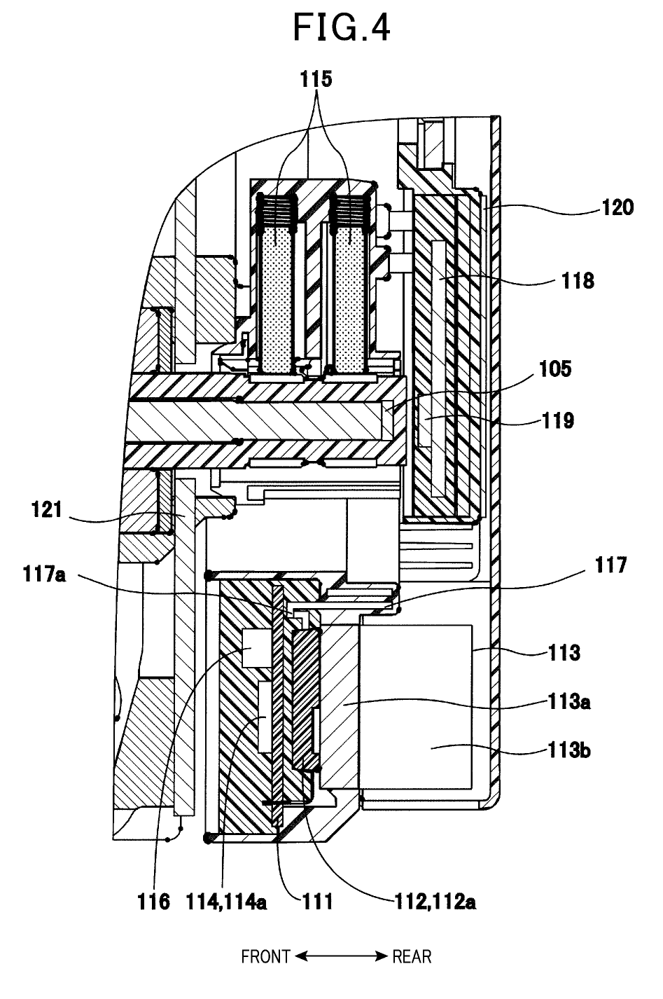

FIG. 4 illustrates the controller-integrated rotating electrical machine 1 according to the second embodiment which has the magnetic member 120 secured to the second wiring board 118. Other arrangements are identical with those in the first embodiment.

The magnetic member 120, as clearly illustrated in FIG. 4, has a major surface adhered or closely attached to a rear major surface of the resin 110g which hermetically seals the second wiring board 118. In other words, the magnetic member 120 is secured to the second wiring board 118 through the resin 110g.

### Beneficial Advantage

The controller-integrated rotating electrical machine 1 of this embodiment is different from that of the first embodiment only in the magnetic member 120 secured to, in other words, retained by the second wiring board 118, thus offering substantially the same advantages as those in the first embodiment.

The magnetic member 120 is, as described above, secured to the second wiring board 118, in other words, placed in the vicinity of the angle position sensing device 119 as compared with the structure of the first embodiment, thus further decreasing the disturbance in magnetic flux flowing from the rotating electrical machine 10 to the magnetic member 120.

The magnetic member 120 may alternatively be secured to the first wiring board 111. This also offers the same advantages as those in the above second embodiment.

### Modifications of First and Second Embodiments

The second wiring board 118 of the first and second embodiments, as already described with reference to FIG. 2, is made of a substantially rectangular plate with the first end (i.e., the inside end) and the second end (i.e., the outside end). The second end is smaller in width than the first end. The second wiring board 118 may, however, be designed to have another configuration.

For instance, the second wiring board 118 may be formed in a wedge-shape to have a width (i.e., a dimension in the radial direction of the rotating electrical machine 10) which increases from the second end on which the angle position sensing device 119 is mounted toward the first end or alternatively formed in a gourd-shape to have a width which varies between the first and second ends.

The second wiring board 118 is, as described above, smaller in size than the first wiring board 111, but however, may be shaped to a length which extends in the radial direction of the rotating electrical machine 10 and has a smaller-area portion disposed inside the U-shape of the first wiring board 111. It is advisable that the second wiring board 118 which is long in the radial direction has a portion which is fixed near the angle position sensing device 119. The distance between the fixed portion and the second end (i.e., the outside side) of the second wiring board 118 will, therefore, be long, thereby minimizing the misalignment of the angle position sensing device 119 with the angle position sensing magnet 105

### Third Embodiment

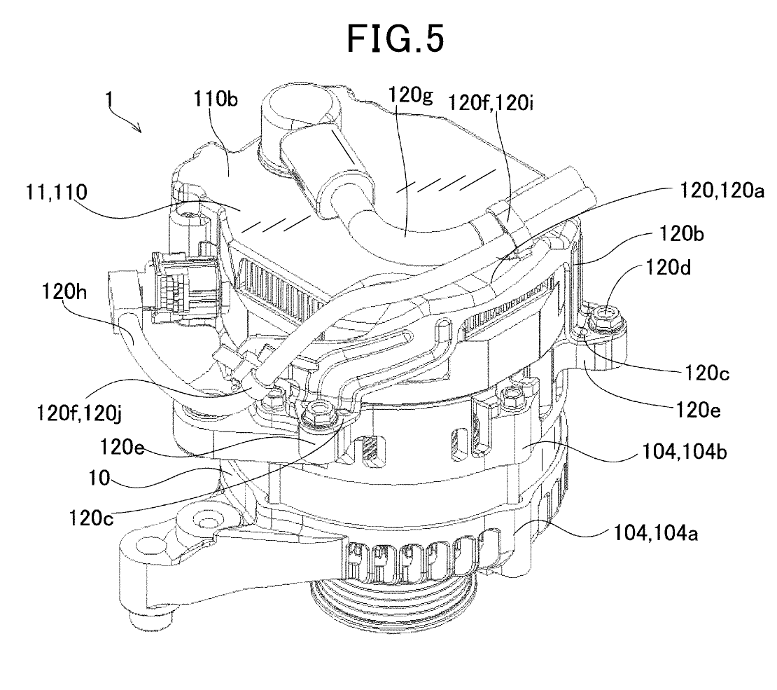

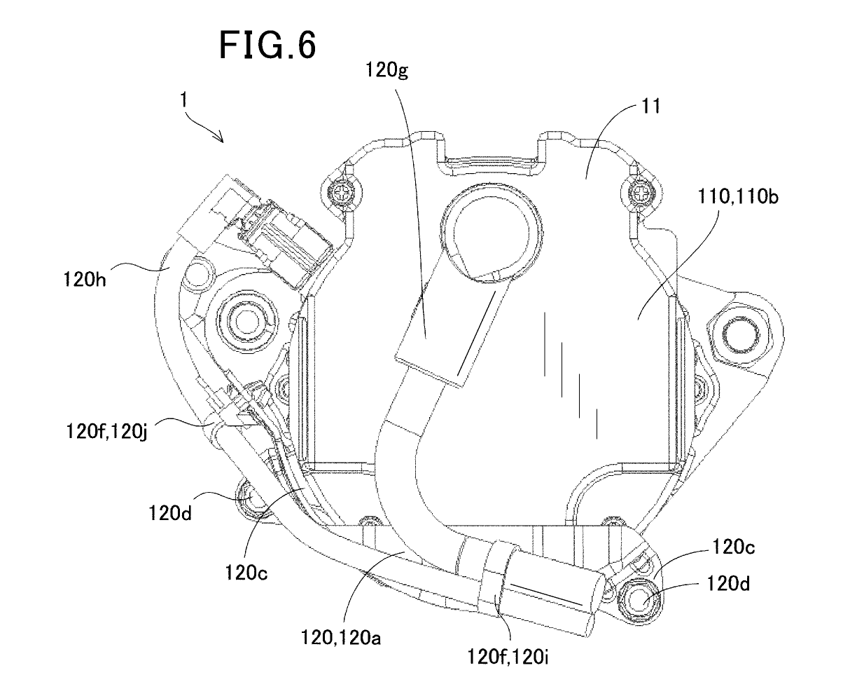

FIGS. 5 and 6 illustrate the controller-integrated rotating electrical machine 1 according to the third embodiment which has the magnetic member 120 secured to an outside surface of the control device 11. Other arrangements are identical with those in the first embodiment, and explanation thereof in detail will be omitted here.

The magnetic member 120 is, as can be seen in FIGS. 5 and 6, arranged in the rear of the rear end of the angle position sensing device 119 of the control device 11 in the axial direction of the controller-integrated rotating electrical machine 1. The magnetic member 120, as can be seen in the perspective view of FIG. 5, is firmly secured to the outside surface of the cover 110b of the casing 110 of the control device 11 (i.e., the rear outer surface of the cover 110b).

The magnetic member 120 includes the main body 120a, the side wall 120b, attachment tabs 120c, and the cable retainers 120f.

The main body 120a is a plate member which extends along the rear surface of the cover 110b of the casing 110. Specifically, the main body 120a is formed in an arch-shape which covers a portion of the surface of the rear end of the cover 110b. More specifically, the main body 120a, as illustrated in a plan view of FIG. 6, is shaped to partially cover an edge portion of the surface of the rear end of the cover 110b. In other words, the main body 120a does not cover a portion of the cover 110b aligned with the rear end of the rotating shaft 102 of the rotating electrical machine 10 or the angle position sensing magnet 105 in the axial direction of the controller-integrated rotating electrical machine 1.

The side wall 120b is formed integrally with the main body 120a and extends along the side surface of the cover 110b of the casing 110. The side wall 120b connects between the main body 120a and the attachment tabs 120c.

The attachment tabs 120c join to the magnetic member 120 to the rotating electrical machine 10. The attachment tabs 120c extend outwardly from the side wall 120b in the radial direction of the controller-integrated rotating electrical machine 1. The attachment tabs 120c have openings through which the bolts 120d are inserted. The attachment of the magnetic member 120 to the rotating electrical machine 10 is achieved by inserting the bolts 120d through the openings of the attachment tabs 120c and threadably fastening the bolts 120d into the brackets 120e of the rear housing 104.

The number of the attachment tabs 120c is not limited to that illustrated (two in this embodiment) as long as the stability of attachment of the magnetic member 120 to the rotating electrical machine 10 is ensured. The more the number of the attachment tabs 120c, the stronger the magnetic member 120 is secured to the rotating electrical machine 10, and the less the misalignment of the magnetic member 120 with the rotating electrical machine 10.

The brackets 120e are formed on the housing 104 (specifically, the rear housing 104b) of the rotating electrical machine 10, but may alternatively be provided on the front housing 104a of the rotating electrical machine 10 or the casing 110 of the control device 11. In the case where the casing 11 of the control device 11 is equipped with the brackets 120e, the attachment tabs 120c are used to secure the magnetic member 120 to the control device 11.

Each of the cable retainers 120f holds an external cable(s) which is connected to the controller-integrated rotating electrical machine 1 or alternatively extends around or near the controller-integrated rotating electrical machine 1 without being joined thereto. In this embodiment shown in FIGS. 5 and 6, one of the cable retainers 120f holds both the electrical power cable 120g and the communication cable 120h, while the other cable retainer 120f holds only the communication cable 120h. The electrical power cable 120g is an electrical line through which electrical current flows when the controller-integrated rotating electrical machine 1 is in operation. The communication cable 120h is an electrical line through which a control signal flows when the controller-integrated rotating electrical machine 1 is in operation.

The type of the cable retainers 120f is not limited to that illustrated as long as they are capable of securing a cable(s) to the rotating electrical machine 10. In this embodiment, one of the cable retainers 120f is implemented by the clamp 120i, while the other cable retainer 120f is implemented by the cable tie 120j. The clamp 120i retains the electrical power cable 120g and the communication cable 120h. The cable tie 120j retains only the communication cable 120h. Attachment of each of the clamp 120i and the cable tie 120j to the rotating electrical machine 10 may be achieved by inserting pawls or tabs of the clamp 120i and the cable tie 120j into opening formed in the main body 120a or the side wall 120b.

The number of the cable retainers 120f is not limited to the illustrated one (two in this embodiment). Specifically, the electrical power cable 120g is held by one of the cable retainers 120f. The communication cable 120h is retained by the two cable retainers 120f.

### Beneficial Advantage

The controller-integrated rotating electrical machine 1 of this embodiment is different from that of the first embodiment only in the magnetic member 120 attached to the outside surface of the controller-integrated rotating electrical machine 1, thus offering substantially the same advantages as those in the first embodiment.

The magnetic member 120 is, as described above, arranged behind the rear end of the angle position sensing device 119 in the axial direction of the controller-integrated rotating electrical machine 1. This minimizes the disturbance in the magnetic flux flowing from the rotating electrical machine 10 toward the magnetic member 120.

Specifically, the magnetic flux, as generated by the angle position sensing magnet 105 of the rotating electrical machine 10, radially flows to the rear of the controller-integrated rotating electrical machine 1 in the axial direction thereof. The magnetic member 120 is placed behind the rear of the angle position sensing device 119 in the axial direction of the controller-integrated rotating electrical machine 1, thereby creating a steady flow of the magnetic flux passing through the magnetic member 120. The angle position sensing magnet 105, the angle position sensing device 119, and the magnetic member 120 are aligned in this order with the direction in which the magnetic flux flows. The angle position sensing device 119 is arranged within the steady flow of magnetic flux moving from the angle position sensing magnet 105 to the magnetic member 120. The disturbance in the magnetic flux flowing from the rotating electrical machine 10 to the magnetic member 120 is, therefore, decreased, thereby ensuring the stability of the measurement accuracy of the angle position sensing device 119.

In this disclosure, the fact that a component of the controller-integrated rotating electrical machine 1 is arranged behind the rear of the angle position sensing device 119 in the axial direction of the controller-integrated rotating electrical machine 1 does not necessarily mean the alignment of the component with the axis of the controller-integrated rotating electrical machine 1.

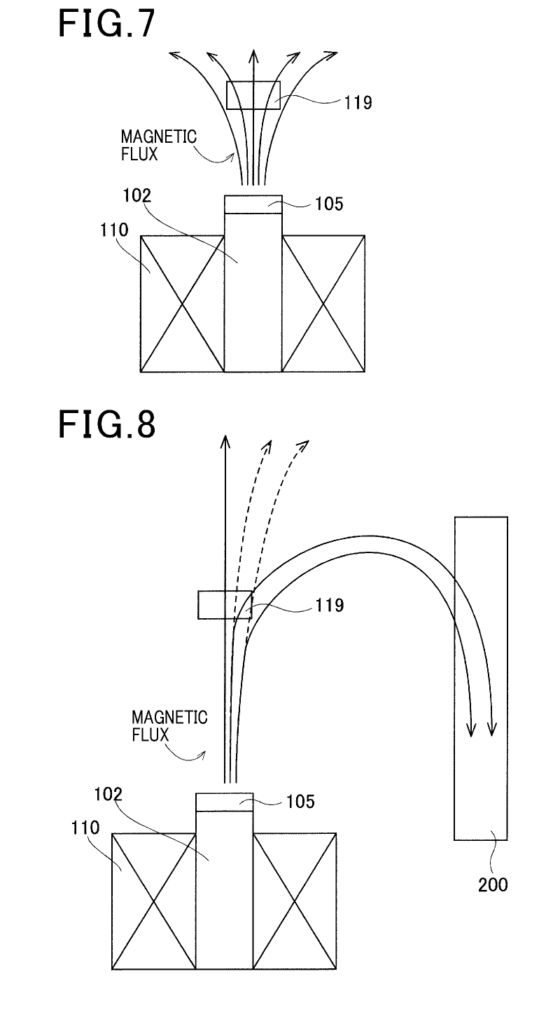

More specifically, in the absence of a magnetic member around the angle position sensing magnet 105 (or the angle position sensing device 119), as illustrated in FIG. 7, the magnetic flux produced by the angle position sensing magnet 105 attached to the rear end of the rotating shaft 102 of the rotating electrical machine 10 uniformly radiates. If the external magnetic member 200 is, as demonstrated in FIG. 8, placed in a region in which the magnetic flux generated by the angle position sensing magnet 105 flows, for example, at a location away from the outside surface of the controller-integrated rotating electrical machine 1, the external magnetic member 200 attracts the magnetic flux, thereby resulting in disturbance in a flow of the magnetic flux. For instance, flows of the magnetic flux, as indicated by broken lines in FIG. 8, which are expected to be created by the angle position sensing magnet 105 in the absence of the external magnetic member 200 will be attracted by the external magnetic member 200 to produce flows of the magnetic flux, as indicated by solid lines, so that the amount of the magnetic flux flowing through the angle position sensing device 119 and the orientation thereof will change, thus resulting in disturbance in the magnetic flux. This leads to a deterioration of measurement accuracy of the angle position sensing device 119.

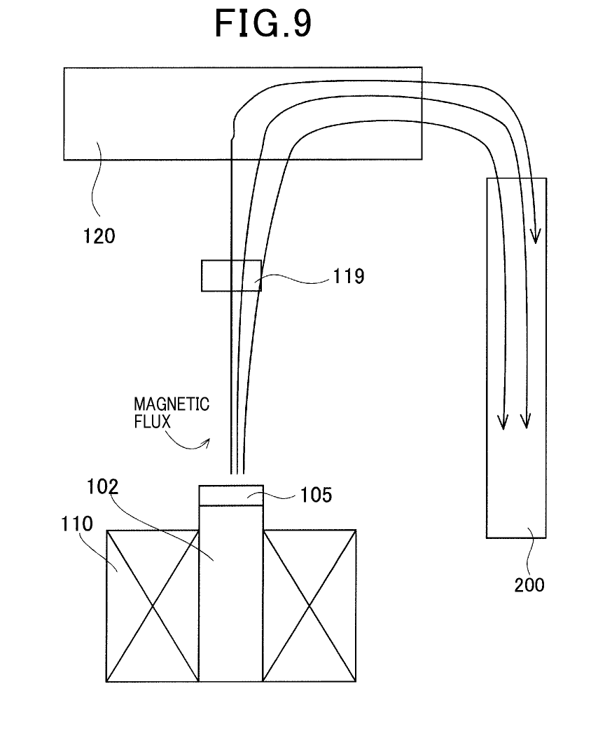

In contrast to the above, when the magnetic member 120 is, as clearly illustrated in FIG. 9, arranged behind the rear end of the angle position sensing device 119 in the axial direction of the controller-integrated rotating electrical machine 1, it will cause the magnetic flux generated by the angle position sensing magnet 105 to be attracted to the magnetic member 120 even in the presence of the external magnetic member 200, thereby creating a steady flow of the magnetic flux penetrating through the magnetic member 120 to minimize the disturbance in the magnetic flux flowing from the rotating electrical machine 10 to the magnetic member 120.

The controller-integrated rotating electrical machine 1 is also designed to have the magnetic member 120 secured to the outside of the cover 110b of the casing 110 of the control device 11 (i.e., the rear outer surface of the cover 110b that is the rear end of the controller-integrated rotating electrical machine 1). The magnetic flux which has been radiated from the rotating electrical machine 10 flows through the magnetic member 120 disposed outside the cover 110b of the casing 110. This prevents the magnetic flux flowing from the rotating electrical machine 10 to the magnetic member 120 from being disturbed.

The structure of the controller-integrated rotating electrical machine 1 of this embodiment, therefore, facilities the attachment of the magnetic member 120 to the cover 110b of the casing of the control device 11 as compared with when the magnetic member 120 is installed inside the casing 110.

In other words, the controller-integrated rotating electrical machine 1 of this embodiment is designed to have the magnetic member 120 secured thereto (i.e., the housing 104 of the rotating electrical machine 10, thereby greatly reducing the disturbance in the magnetic flux. The securement of the magnetic member 120 to the housing 104 of the controller-integrated rotating electrical machine 1 minimizes a risk of misalignment of the magnetic member 120 (i.e., misalignment of the angle position sensing device 119 with the magnetic member 120. This results in stability in minimizing the disturbance in the magnetic flux penetrating through the angle position sensing device 119.

The magnetic member 120 is, as described above, equipped with the cable retainers 120f which hold the electrical power cable 120g and the communication cable 120h.

The use of the cable retainers 120f attached to the magnetic member 120 facilitates securement of the electrical power cable 120g and the communication cable 120h to the controller-integrated rotating electrical machine 1 without use of additional fasteners. The securement of the electrical power cable 120g and the communication cable 120h to the controller-integrated rotating electrical machine 1 minimizes a risk of breaking thereof or removal of connectors to which the electrical power cable 120g and the communication cable 120h are coupled.

### First Modification of Third Embodiment

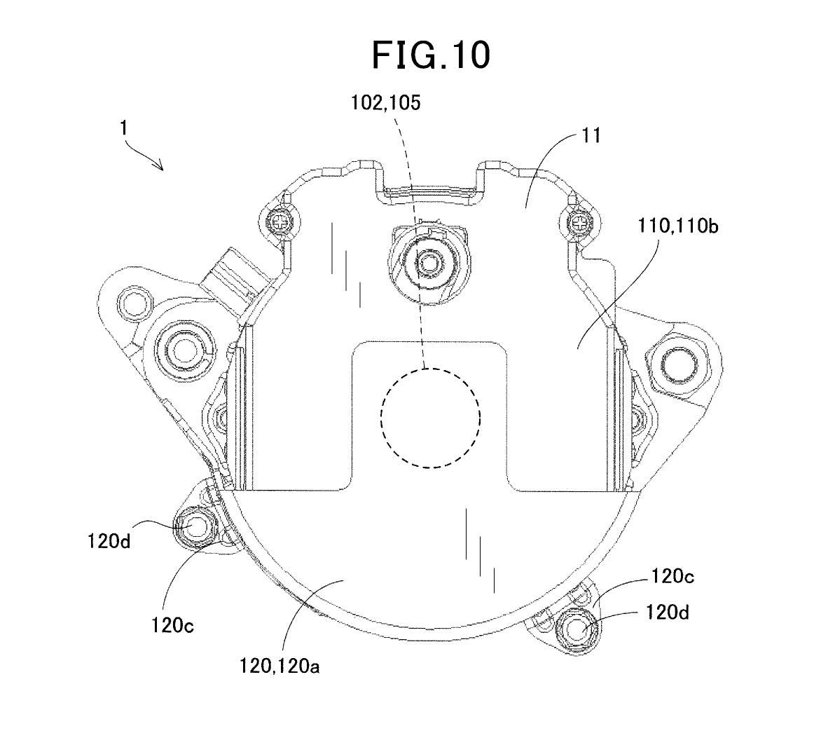

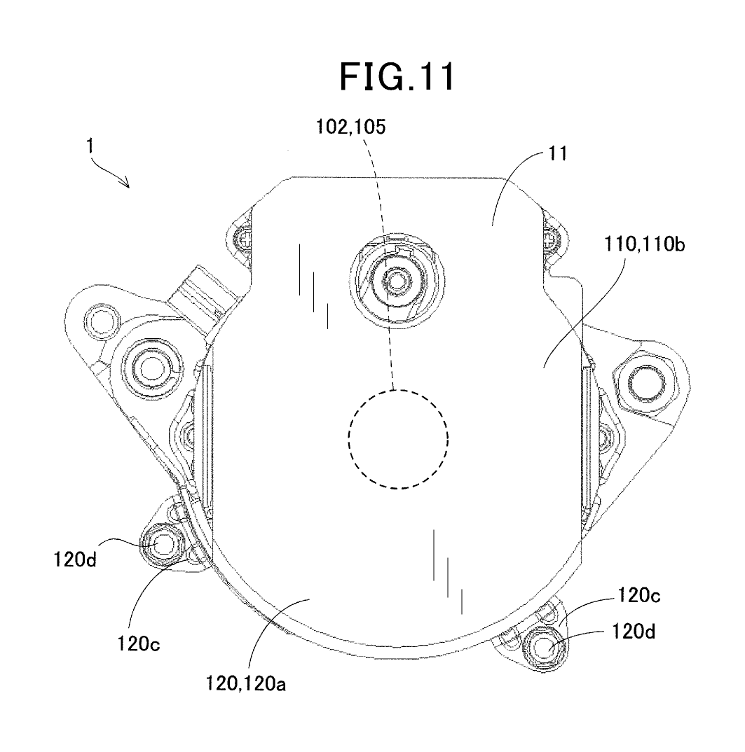

The controller-integrated rotating electrical machine 1 of the third embodiment has the substantially arch-shaped main body 120a of the magnetic member 120. Specifically, the main body 120a, as can be seen in FIG. 6, has an arc-shaped peripheral outline. The main body 120a may alternatively be designed to have a configuration illustrated in FIG. 10 or 11. FIGS. 10 and 11 are plan views, like FIG. 6, which illustrate the magnetic member 120 from which the cables 120g and 120h are removed for the sake of visibility.

The main body 120a of FIG. 10 is formed in a substantially T-shape with an arc-shaped side profile. Specifically, the main body 120a has the center extension 220 which extends cover the center of the rear surface of the cover 110b.

The main body 120a of FIG. 11 is larger in size than the one in FIG. 10. Specifically, the main body 120a has an arc-shaped side profile and also has an arear covering substantially the whole of the rear surface of the cover 110b.

The main body 120a of the magnetic member 120 in either of FIGS. 10 and 11 is shaped to at least cover the central portion of the rear surface of the cover 110b. The center or the central portion of the cover 110b is aligned with the axis of the rotating shaft 102 of the rotating electrical machine 10 (i.e., the angle position sensing magnet 105 attached to the rear end of the rotating shaft 102) in the axial direction of the controller-integrated rotating electrical machine 1. In other words, the magnetic member 120 is arranged at a minimum distance from the angle position sensing magnet 105.

### Beneficial Advantage

The controller-integrated rotating electrical machine 1 of this modification is different from that of the third embodiment only in configuration of the main body 120a of the magnetic member 120, thus offering substantially the same advantages as those in the third embodiment.

The structure of the controller-integrated rotating electrical machine 1 has a decreased distance between the angle position sensing magnet 105 and the magnetic member 120, thereby further reducing the disturbance in magnetic flux flowing from the rotating electrical machine 10 to the magnetic member 120.

Additionally, the main body 120a of the magnetic member 120 in each of the FIGS. 10 and 11 is smaller in area than the one in the above embodiments. In other words, the magnetic member 120 (i.e., the main body 120a) covers or overlaps an increased area of the cover 110b and thus functions as a thermal shield to block transfer of heat from outside the controller-integrated rotating electrical machine 1 to the rotating electrical machine 10 and the control device 11, thereby resulting in an increase in overall heat resistance of the controller-integrated rotating electrical machine 1.

As apparent from the above discussion regarding the third embodiment and the modification of the third embodiment, the magnetic member 120 needs not necessarily be located on an extended line of the axis of the angle position sensing device 119 as long as it is arranged behind the rear of the angle position sensing device 119 in the axial direction of the controller-integrated rotating electrical machine 1.

### Second Modification of Third Embodiment

The control device 11 in each of the third embodiment and the first modification of the third embodiment is, like in the first and second embodiments, equipped with the first wiring board 111 and the second wiring board 118, but is not limited to such a structure.

For instance, the controller-integrated rotating electrical machine 1 may have, like in the prior art structure, a single circuit board on which the angle position sensing device 119 is mounted along with the inverter circuit 112, the field circuit 114, and the control circuit 116.

### First Modifcation of First to Third Embodiments

The controller-integrated rotating electrical machine 1 in the first to third embodiment and the above modifications is designed to use an angle position sensor (also called a rotational position sensor) made up of the angle position sensing magnet 105 and the angle position sensing device 119 to measure the rotation (i.e., an angle of rotation) of the rotating shaft 102, but is not limited to such a structure. For instance, the angle position sensor may be implemented by a resolver to measure degrees of rotation of the rotating shaft 102.

### Second Modification of First to Third Embodiments

The controller-integrated rotating electrical machine 1 in the first to third embodiment and the above modifications is designed to have the single angle position sensing device 119 installed therein, but may alternatively be equipped with two or more angle position sensing devices 119. For instance, the controller-integrated rotating electrical machine 1 may have a plurality of angle position sensing devices 119 mounted away from each other on the second wiring board 118. Specifically, the second wiring board 118 has a first surface and a second surface opposed to each other through a thickness thereof. The angle position sensing devices 119 may be all disposed away from each other on only one of the first and second surfaces of the second wiring board 118 or alternatively both on the first surface and on the second surface of the second wiring board 118. In the case where the angle position sensing devices 119 are placed on both the first and second surfaces of the second wiring board 118, the layout of some of the angle position sensing devices 119 on the first surface may be symmetrical with that of the other angle position sensing devices 119 on the second surface with respect to the thickness of the second wiring board 118.

### Third Modification of First to Third Embodiments

The controller-integrated rotating electrical machine 1 in the first to third embodiment and the above first to third modifications is equipped with the rotating electrical machine 10 which has field winding 101b in the rotor 101, but is not limited to such a structure. For instance, the controller-integrated rotating electrical machine 1 may be equipped with the rotating electrical machine 10 which has a rotor 101 with permanent magnets.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiment which can be embodied without departing from the principle of the invention as set forth in the appended claims.

What is claimed is:

1. A controller-integrated rotating electrical machine comprising:
a rotating electrical machine which is equipped with a stator with an armature winding and a rotor with a field winding;
a control device which is equipped with a control circuit and an angle position sensing device, the control circuit working to control an inverter circuit to supply electric power to said armature winding, the angle position sensing device working to measure an angular position of the rotor;
a first substrate on which the control circuit is mounted, the first substrate being disposed in the control device; and
a second substrate on which the angle position sensing device is mounted, the second substrate being disposed in the control device,
wherein the first substrate is located closer to the rotating electrical machine than the angle position sensing device is in an axial direction of the rotor, the first substrate being at a distance from the angle position sensing device.

2. A controller-integrated rotating electrical machine as set forth in claim 1, wherein said control device includes a switching module constituting said inverter circuit and a bus bar which connects with the switching module, and wherein a joint between the switching module and the bus bar is located closer to a front of the controller-integrated rotating electrical machine than the switching module is in an axial direction of the controller-integrated rotating electrical machine.

3. A controller-integrated rotating electrical machine as set forth in claim 1, wherein the control device includes a switching module constituting said inverter circuit and a heat sink which works to dissipate heat generated by the switching module, and wherein said angle position sensing device is located closer to an axis of the rotor than the heat sink is in a radial direction of the rotor.

4. A controller-integrated rotating electrical machine as set forth in claim 1, wherein the control device includes a switching module constituting said inverter circuit and a heat sink which works to dissipate heat generated by the switching module, and wherein said angle position sensing device is located closer to a front of the controller-integrated rotating electrical machine than a rear end of the heat sink is in an axial direction of the controller-integrated rotating electrical machine.

5. A controller-integrated rotating electrical machine as set forth in claim 1, wherein said second substrate is smaller in size than said first substrate.

6. A controller-integrated rotating electrical machine as set forth in claim 1, wherein the angle position sensing device is implemented by a magnetic angle sensor.

7. A controller-integrated rotating electrical machine as set forth in claim 1, wherein at least one of the first substrate and the second substrate of the control device is covered with resin.

8. A controller-integrated rotating electrical machine as set forth in claim 1, wherein the control device has a magnetic member which is disposed behind a rear end of the angle position sensing device.

9. A controller-integrated rotating electrical machine as set forth in claim 8, wherein the control device is equipped with a casing in which the first substrate and the second substrate are disposed and which is located behind a rear end of the rotating electrical machine in an axial direction of the controller-integrated rotating electrical machine, and wherein said magnetic member is secured to the casing.

10. A controller-integrated rotating electrical machine as set forth in claim 8, wherein the magnetic member is secured to one of the first substrate and the second substrate.

11. A controller-integrated rotating electrical machine as set forth in claim 1, wherein the control device is equipped with a magnetic shield disposed between the second substrate and the rotating electrical machine.

12. A controller-integrated rotating electrical machine comprising:
a rotating electrical machine which is equipped with a stator with an armature winding and a rotor;
a control device which is equipped with a control circuit and an angle position sensing device, the control circuit working to control an inverter circuit to supply electric power to said armature winding, the angle position sensing device working to measure an angular position of the rotor; and
a magnetic member (120) which is disposed behind a rear end of the angle position sensing device in an axial direction of the controller-integrated rotating electrical machine.

13. A controller-integrated rotating electrical machine as set forth in claim 12, wherein the magnetic member is attached to an outside surface of a casing of the control device.

14. A controller-integrated rotating electrical machine as set forth in claim 12, wherein the magnetic member is secured to one of the rotating electrical machine and the control device.

15. A controller-integrated rotating electrical machine as set forth in claim 12, wherein the magnetic member includes a cable retainer which holds a cable.
